(19) United States
(12) Patent Application Publication
(10) Pub. No.: US 2006/0231996 A1
(43) Pub. Date: Oct. 19, 2006

(54) Rotary folder comprising a cutting device for cross-cutting at least one web

(76) Inventors: Michael Held, Heuchelheim (DE); Sebastian Alois Prüm, Kaiserslautern (DE)

Correspondence Address: Doughlas R. Hanscom;Jones, Tullar and Cooper, P.C., P.O. Box 2266 Eads Station, Arlington, VA, 22202, US

(21) Appl. No.: 10/555,091

(22) PCT Filed: Apr. 30, 2004
(86) PCT No.: PCT/EP04/50656

§ 371 Date: Nov. 2, 2005

(30) Foreign Application Priority Data
May 2, 2003 (DE) 103 19 774.5

(51) Int. Cl. B41F 13/58

(52) U.S. Cl. 270/5.02

(57) ABSTRACT

A rotary folder includes two cutting devices for cross-cutting at least a first web. The cutting devices are cutting or counter cylinders that can rotate together and that define gaps in conjunction with a conveying cylinder. A path of web conveyance runs through each of these gaps. The conveying cylinder or the cutting cylinders support at least one blade for cutting of a product from the webs. The conveying cylinder comprises a retaining device for retaining a cut-off signature and for conveying the signature through the respective gap. The conveying cylinder or the counter cylinders comprise thrust bearings that interact with the blade.

### CROSS-REFERENCE TO RELATED APPLICATIONS

This patent application is the U.S. national phase, under 35 USC 371, of PCT/EP2004/050656, filed Apr. 30, 2004; published as WO 2004/096687 A1 on Nov. 11, 2004, and claiming priority to DE 103 19 774.5, filed May 2, 2003, the disclosures of which are expressly incorporated herein by reference.

### FIELD OF THE INVENTION

The present invention is directed to a wheel folding apparatus with a cutting device for accomplishing the transverse cutting of at least one web of material.

### BACKGROUND OF THE INVENTION

A wheel folding apparatus is typically employed, for example, to separate paper webs, which have been imprinted in a web-fed rotary printing press, into individual signatures by use of a cutting device, and to fold the individual signatures.

Generally known wheel folding devices of this type usually comprise cutting devices which are provided with a transport cylinder and with a cutting cylinder, which cylinders are mutually rotatable and which define a gap through which a conveying path for the web of material to be cut extends. The cutting cylinder supports at least one cutter, each which cutter cuts respectively one signature off the web of material when it passes through the gap.

DE 25 17 000 C2 shows a folding apparatus with a spur cylinder and with a cutting blade cylinder, which cooperate to form a single cutting gap.

DE 35 27 710 A1 and EP 0627 310 A1 both disclose folding apparatus. Two folding blade cylinders work together with a folding jaw cylinder. A single cutting cylinder is assigned to each one of these folding blade cylinders.

### SUMMARY OF THE INVENTION

The object of the present invention is directed to providing a wheel folding apparatus with a cutting device for transverse cutting of at least one web of material.

In accordance with the present invention, this object is attained by.

The advantages which can be obtained by the present invention lie, in particular, in that with only a small outlay for apparatus, the present invention makes possible the combining of two webs of material, which two material webs are fed to the cutting gaps on two transport carriages, into a common product. The present invention also allows the processing of a web of material, with a very large number of layers, by combining two partial webs.

Processing of webs of materials, which are composed of a large number of layers, by the use of a folding apparatus with a single cutting gap, such as is described in DE 25 17 000 C2, entails difficulties for several reasons. For one, traction rollers, which are customarily provided for use in setting a required tension in the web of material, act directly only the respectively outermost layers of the web of material. The force exerted by such traction rollers is only indirectly transmitted to the inner layers of the web of material by friction of the layers of material against each other. These frictional forces are not accurately controllable, particularly if it is necessary to guide the web around curves, such as, for example, to loop it around a roller. Therefore, the tension of the inner layers of such a web are harder to control, the greater the number of layers there are. Also, the forces required for processing a web, either during cutting of the web or during pushing of the spur points into the web, are all the greater, the greater the number of layers there are. With the wheel folding apparatus in accordance with the present invention, it is possible to combine a product with a defined number of pages from several partial webs, which had been cut separately of each other and placed on the spurs. Since the forces required for cutting these partial webs and, if required, for placing these partial webs on spur points, are less than the corresponding forces that are required when processing a single web with the same defined number of pages, the wheel folding apparatus of the present invention can be constructed lighter and therefore more cost-effectively, without any loss in quality, compared with prior devices.

Further advantages of the wheel folding apparatus of the present invention include that the cutting device eliminates the danger of re-cutting already separated signatures, in the course of a further passage of such signatures through a cutting gap. This is accomplished without requiring elaborate shifting devices, or an extraordinarily high degree of precision when controlling the rotations of the individual cylinders of the cutting device.

To prevent the second cutting blade from again cutting through the first web, during the passage of the web through the second cutting gap, the rotation of the two cutting cylinders is preferably synchronized. During its passage through the second cutting gap, the second cutting blade engages a cut which was formed by the first cutting blade of the first web.

To make the engagement of the second cutting blade with this previously made cut easier, assemblies are preferably provided for use in moving apart the cut edges of the first web that were generated by the first cutter in the course of cutting the first web. During its passage through the gap, the second cutter encounters a gap of non-vanishing width that has been formed in the first web.

In an embodiment of the wheel folding apparatus in accordance with the present invention, in which the cutting cylinder in the cutting device also takes on the function of a transport cylinder for the separated products, the single signature is located between the two cutters, by which it had been cut, so long as it is maintained on the cutting or the transport cylinder. It is sufficient, during this time, that the cutters and the signature do not move in relation to each other. This is done in order to assure that the signature is not cut again in the course of another passage of the signature through the cutting gap.

### BRIEF DESCRIPTION OF THE DRAWINGS

Preferred embodiments of the present invention are represented in the drawings and will be described in greater detail in what follows.

Shown are in:

FIG. 1, a schematic side elevation view of a portion of a wheel folding apparatus with a cutting device in accordance with the present invention, in

FIGS. 2 to 5, respectively partial sectional views of the transport cylinder and of one cutting cylinder in different embodiments of the present invention, in

FIG. 6, a schematic side elevation view of a portion of a different embodiment of a wheel folding apparatus with a cutting device in accordance with the present invention, in

FIG. 7, an enlarged representation of a detail of a portion of the device shown in FIG. 6, in

FIG. 8, a schematic representation of a mode of operation, in

FIG. 9, a schematic representation of another mode of operation, and in

FIG. 10, a further preferred embodiment of a wheel folding apparatus in accordance with the present invention.

### DESCRIPTION OF THE PREFERRED EMBODIMENTS

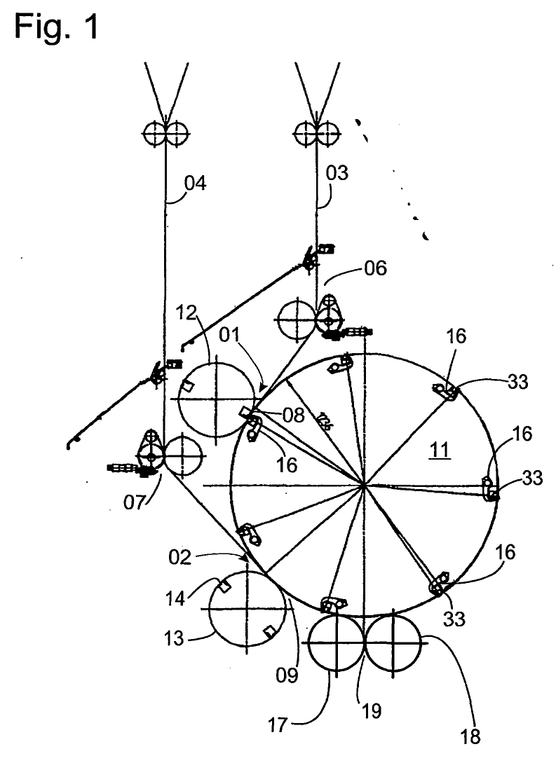

A schematic side elevation view of a portion of a wheel folding apparatus in accordance with the present invention is represented in FIG. 1. This wheel folding apparatus has two inlets 01, 02 for multi-layered webs 03, 04 of material, and in particular for paper webs 03, 04, which will be called inner or outer web 03, 04, respectively, in what follows. Both webs 03, 04 pass throughtraction roller pairs 06, 07, respectively, for setting their tension. Both of these webs 03, 04 meet a transport cylinder 11 at the heights of cutting gaps 08, 09, respectively, between the transport cylinder 11, on the one hand, and one of two cutting cylinders 12, 13 on the other. Instead of two such inlets 01, 02 and two cutting gaps 08, 09, it is also possible to provide three or more of each. In the course of this passage, the webs 03, 04 preferably first make contact with the respective cutting cylinder 12, 13 and subsequently make contact with the transport cylinder 11. The webs 03, 04 first loop around the cutting cylinder 12, 13 and then loop or wrap around the transport cylinder 11.

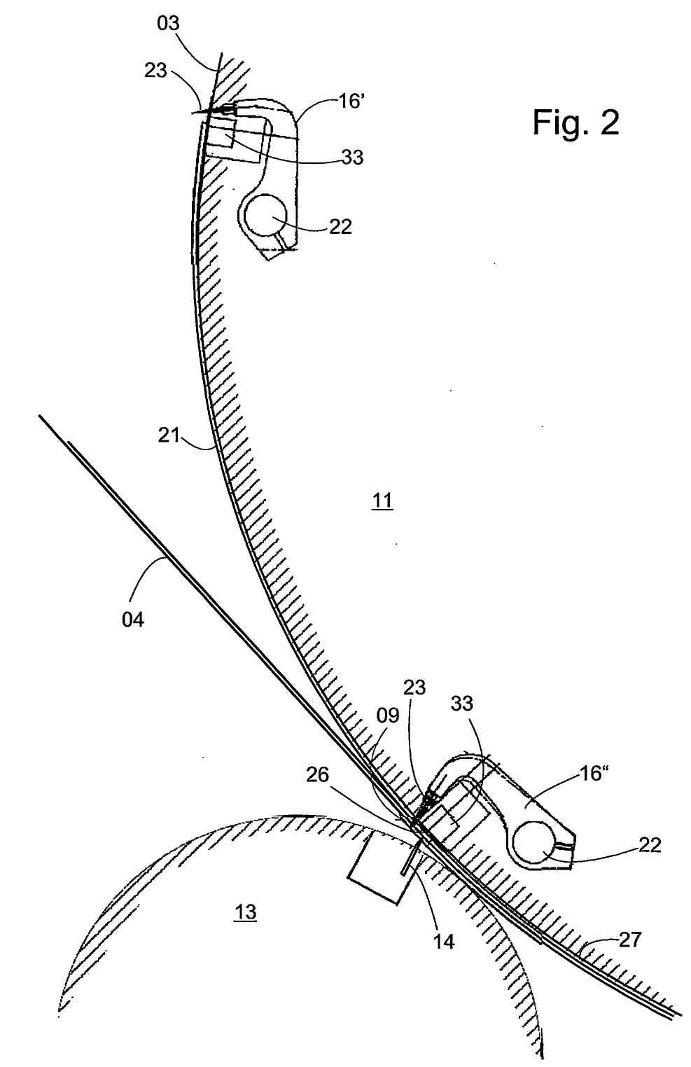

Each cutting cylinder 12 or 13 has a circumference corresponding to at least one, and preferably to two lengths of the signatures 21, 27 to be produced from the webs 03, 04, and each cutting cylinder 12 or 13 supports two cutters 14, as may be seen more clearly in FIG. 2.

The circumference of the transport cylinder 11 corresponds to more than five, and in particular corresponds to seven lengths of the signatures 21, 27. Seven counter-cutting strips, which may be, for example, hard rubber strips, and which are inserted at equal spaced circumferential distances into the circumferential face of the transport cylinder 11, are used as stops 33. Each of these stops 33 works together with a cutter 14 when cutting the webs 03, 04. A holding device 16 is arranged at the transport cylinder 11 adjoining each one of the stops 33, and may be, for example, a spur strip 16 with extendible spur needles 23, as may be seen in FIGS. 2 to 5.

In the position of the folding apparatus represented in FIG. 1, a cutter 14 of the cutting cylinder 12 and a stop 33 of the transport cylinder 11 are shown as passing through the first cutting gap 08, and cooperate, in the process, to cut the inner web 03. The leading edge of the inner web 03, which is formed during this cutting, has been speared or impaled on the spur needles 23 of a spur strip 16 which spur strip 16 had been extended immediately prior to its reaching the cutting gap 08. These spur needles 23 continue to hold the leading edge of the inner web 03 firmly on the surface of the transport cylinder 11 during further transport of the inner web 03.

The signature 21, which has now been cut off from the inner web 03 in this way, is conveyed on the transport cylinder 11 to the second cutting gap 09, where the outer web 04 is placed on top of it. The outer web 04 is also speared or impaled by the spur needles 23 of the spur strip 16.

The rotations of the two cutting cylinders 12, 13 are synchronized in such a way that a cutter 14 of the second cutting cylinder 13 always passes through the second cutting gap 09 simultaneously with the passage of a small gap that has been formed between two successive signatures 21 which were cut from the inner web 03,and the passage of a stop 33 through gap 09. Different techniques for forming this gap will be explained in what follows with the aid of, and with reference to, FIGS. 2 to 5.

In the example represented in FIG. 1, an angular distance between the two cutting gaps 08, 09 is approximately 50°. This angular distance can differ from an angular distance between the spur strips 16 from each other of approximately 51.5° or a multiple thereof. Cutting is thus not performed simultaneously at both of the cutting gaps 08, 09. Even a half-number multiple of this value is disadvantageous from the point of view of avoiding vibrations.

Following its passage through the second cutting gap 09, each spur strip 16 supports a total product which is composed respectively of a signature 21 cut off from the inner web 03, and a signature 27 cut off from the outer web 04. Seven products are formed during each revolution of the transport cylinder 11. This is the same result as if both webs 03, 04 had been brought along in the customary manner through a common inlet 01, 02. Since the cutting off of each individual signature 21, 27 is spread over two cutting steps at the two spaced cutting gaps 08, 09, the force which must be employed in each cutting step is less. This means that a satisfactory, more even running of the machine can be more easily maintained.

Two cylinders 17 and 18, and in particular two folding rollers 17 and 18, which together form a gap 19, and in particular which form a folding gap 19, have been placed, in a contactless manner, against the cutting and transport cylinder 11. Seven folding blades, which are not specifically represented in FIG. 1, are attached to the transport cylinder 11, each of which folding blades is extended when reaching the folding gap 19 between the folding rollers 17, 18 in order to push the products, which are being transported on the transport cylinder 1 1, and in a manner that is known per se, into the folding gap 19, with the products leading with a desired fold line that is located approximately centered on the sides of the signatures 21, 27, and to fold them in this way. The folded products pass through the folding gap 19 and, in a generally known manner, fall onto a paddle wheel, which is not specifically represented, and are placed by the paddle wheel on a conveyor belt.

FIG. 2 shows a detailed view of the second cutting gap 09 and its surroundings, in accordance with a first preferred embodiment of the present invention. Two of the seven spur strips 16 of the transport cylinder 11 are represented in FIG. 2 and are identified as spur strips 16′, 16″. Each of these spur strips 16′, 16″ is pivotable around a shaft 22 in a controlled manner and has spur needles 23 which are oriented in such a way that their respective tips, which are extending radially from the circumference of the transport cylinder 11, are farther away from the center of the shaft 22 than are their bases, which are located inside the transport cylinder 11. The spur needles 23 of the spur strip 16′ are depicted in FIG. 2 as being situated in a comparatively far extended position, in which extended position they had also previously passed through the first cutting gap 08. This identical position is shown by dashed lines at the location of the spur strip 16″.

In comparison with this extended position of the spur strip 16′, the spur strip 16″ has been pivoted back some distance into the interior of the transport cylinder 11. This pivot movement causes a displacement of the intersection point between the spur needles 23 and the surface of the transport cylinder 11 in a circumferential direction which is opposite to the direction of rotation of the transport cylinder. Because of this displacement, the signature 21 which is held by the spur strip 16″, has been shifted slightly in a direction that is also opposite the direction of rotation of the transport cylinder 11. This shifting is in comparison to the position in which the signature 21 had been cut off the inner web 03 in the first cutting gap 08. Following its passage through the second cutting gap 09, the spur strip 16″ returns to the extended position shown in dashed lines, or even extends to a further extended position in order to cancel, or to overcompensate for, the prior rear displacement of the signature 21. A small gap 26 is formed in this way between the signature 21 and a previous signature 27 which had been cut off immediately prior to this, and into which small gap 26 the cutter 14 of the second cutting cylinder 13 can extend and can, in this way, press the outer web 04 against the stop 33 and can sever it, without the danger arising of again cutting one of the previously cut signatures 21, 27.

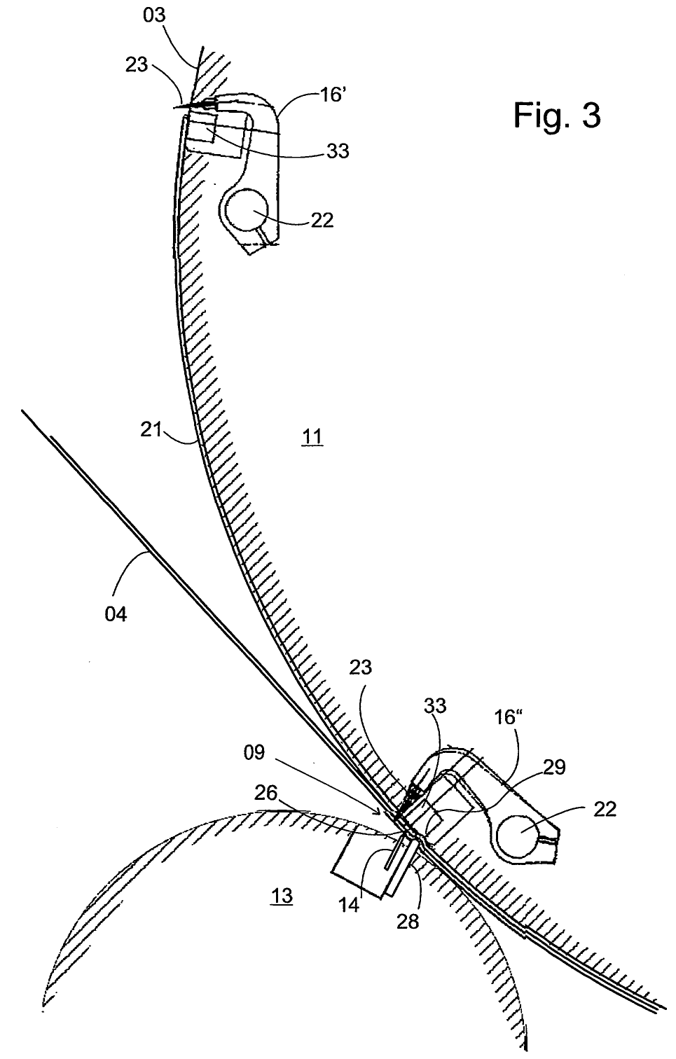

FIG. 3 shows an alternative embodiment of the transport cylinder 11 and of the cutting cylinder 13, in accordance with the present invention, in a partial cross-sectional view that is analogous to the view of FIG. 2. In connection with each cutter 14, the cutting cylinder 13 has a strip 28, which projects past theouter circumference of cutting cylinder 13 and which passes through the cutting gap 09 shortly ahead of the respective associated cutter 14. A complementarily shaped groove 29 is formed in the transport cylinder 11, and is located opposite the strip 28 during each gap passage. The strip 28 thus presses a trailing edge area of the first signature 27, which was cut off the inner web 03, as well as the outer web 04, into the groove 29. The trailing edge of the previously cut signature 27 is pulled ahead by this and the gap 26 is opened. Therefore, with this embodiment of the present invention, it is not necessary for the spur strip 16″ to pivot outward again after its passage through the cutting gap 09 in order to form the gap 26.

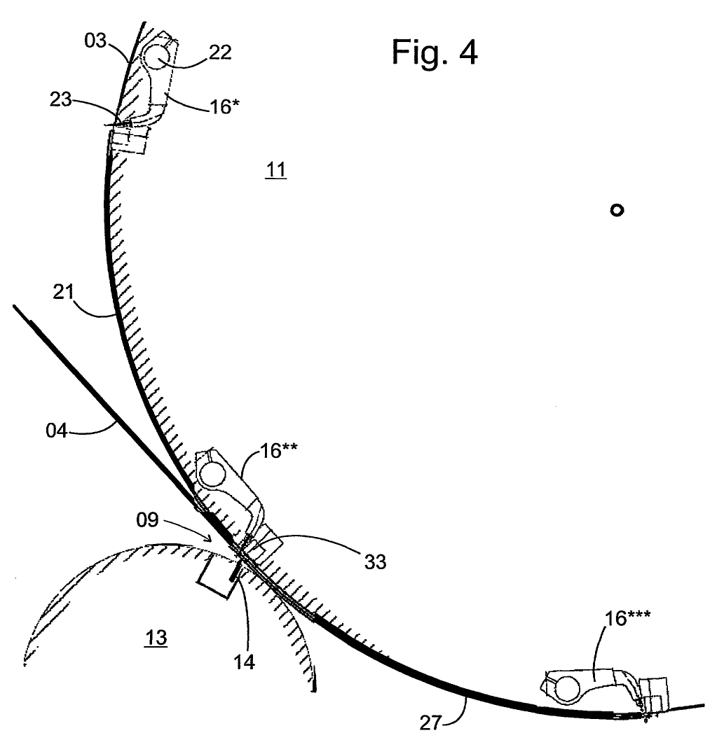

A third preferred embodiment of the present invention is represented in FIG. 4, again by the use of a partial cross-sectional view taken through the transport cylinder 11 and the cutting cylinder 13. The cutting cylinder 13 is identical to the one depicted in FIG. 2. The transport cylinder 11 differs from the prior ones by the arrangement of the shafts 22 around which the spur strips 16 are pivotable. In the embodiments in accordance with FIGS. 2 and 3, these shafts 22 are located ahead of the spur needles 23, in the direction of rotation of the transport cylinder. These shafts 22 are arranged behind the spur needles 23 in the embodiment shown in FIG. 4. The orientation of the spur needles 23, in relation to the surface of the transport cylinder 11, is the same in all cases. The spur needles 23 are inclined slightly forward, and in the direction of rotation of the transport cylinder 11, with respect to a line that is normal to the cylinder surface. Atension that is acting on the material which is speared or impaled on the spur needles 23 keeps the material pressed against the surface of the transport cylinder 11.

A changed course of the pivot movement of the spur strips, which are here identified by 16*, 16**, 16***, results from the changed arrangement of the shafts 22. The spur strip 16*, which is still situated at a distant that is relatively far from the cutting gap 09, is in a position in which it is comparatively only slightly extended, in which its spur needles 23 extend only far enough past the circumference of the transport cylinder 11 to hold the inner web 03. The spur strip 16* is extended further only shortly before it reaches the second cutting gap 09, in order to also be able to puncture the outer web 04, which positioning can be perceived at the spur strip 16**. With this embodiment, the upward or rapidly outward movement of the spur needles 23 causes a shifting of their intersection with the circumference of the transport cylinder 11 in a direction that is opposite to the direction of movement of the transport cylinder 11. Therefore, the movement of the leading edge of the signature 21 which is held by the spur strip 16** is away from the impact point of the cutter 14 on the stop 33. In opposition to this, the spur needles 23 of the spur strip 16*** have been retracted a short distance into the transport cylinder 11 in order to move the signature 27 they are holding forward in the circumferential direction and in this way to open the resultant gap 26 that is provided at the location of the stop 33.

With this third embodiment, several direction changes of the movement of the spur needles 23, in the course of the revolution of the transport cylinder 11, are avoided.

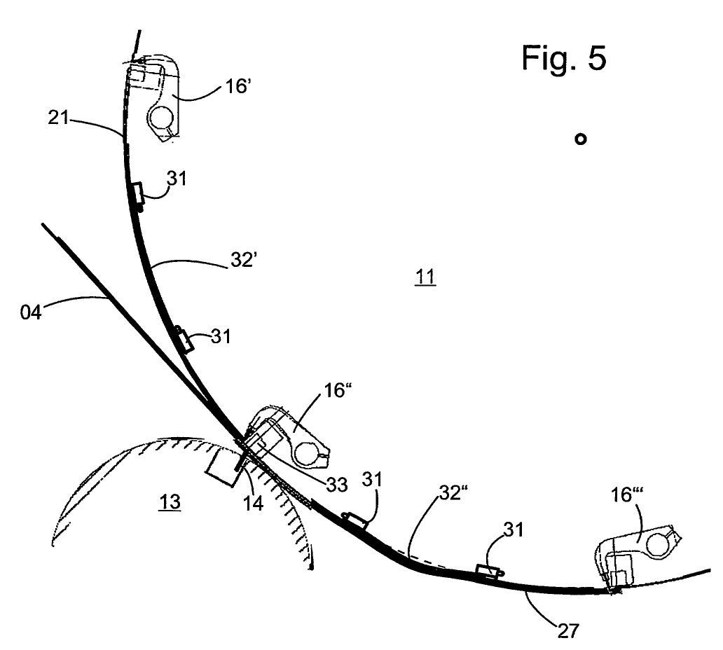

A fourth embodiment of the cutting device in accordance with the present invention is represented in FIG. 5, again in a partial cross-sectional view analogous to FIG. 4.

In this fourth embodiment, segments 32′, 32″ . . . , are arranged on the circumference of the transport cylinder 11 with each such segment 32′, 32′″ . . . , being located respectively between two successive spur strips 16′, 16″, 16′″, . . . , and are used for increasing the circumference of transport cylinder 11. Each one of these segments 32′, 32″ is comprised of a plurality of flexible disks, which are arranged side-by-side in the axial direction of the transport cylinder 11 and which are spaced apart by gaps. In the course of the passing of the finished cut signatures 21, 27 on to the folding rollers 17, 18, these gaps are used as the outlet openings for tines of a folding blade, which is not specifically represented. The ends of each of the disks 32′, 32′″ . . . , are anchored on head strips 31, which head strips 31 can be shifted in the circumferential direction of the transport cylinder 11.

The segment 32′ is in a configuration wherein the course of its disks corresponds to the cylindrical shape of the transport cylinder 11. After each suchsegment 32′ has passed through the cutting gap 09, its head strips 31 are shifted circumferentially toward each other, so that its disks form a protrusion that is extending beyond the circumference of the transport cylinder 11, as is shown by the depiction of the segment 32″. Because of this protrusion, the distance between the spur strips 16″ and 16′″, as measured along the outer circumferential surface of the transport cylinder 11, is greater than the corresponding distance between the spur strips 16′ and 16″, wherein the latter distance corresponds to the length of the signatures 21, 27 that are formed at the cutting gap 06. Therefore, the bulging of the segment 32″ causes the formation of the gap 26 between the signatures 21 and 27, into which gap 26 the cutter 14 of the second cutting cylinder 13 can extend.

The second cutting cylinder 13 is arranged adjacent the circumference of the transport cylinder 11 so that it cuts in a phase-shifted manner.

The cut of the second cutting cylinder 13 on the transport cylinder 11 takes place close to, in particular 10 mm, next to the other cut of the first cutting cylinder 12.

The cutting cylinders 12 and 13 are arranged sequentially in the circumferential direction on the transport cylinder 11.

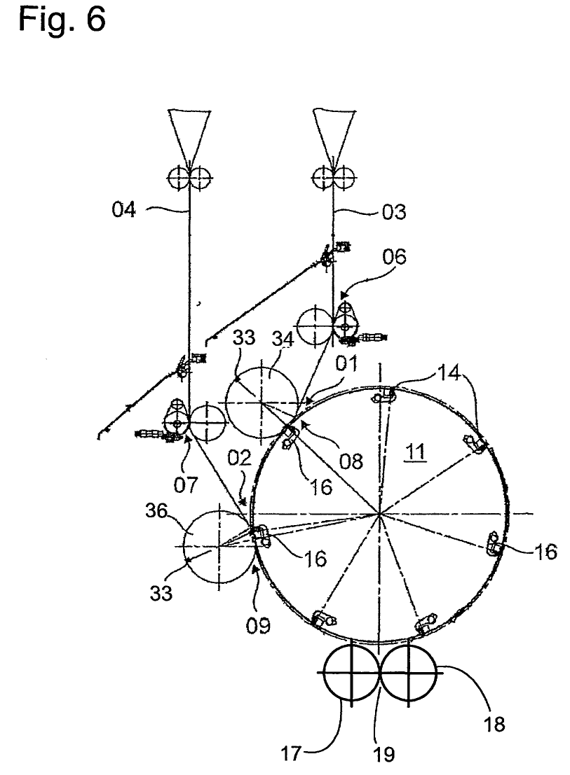

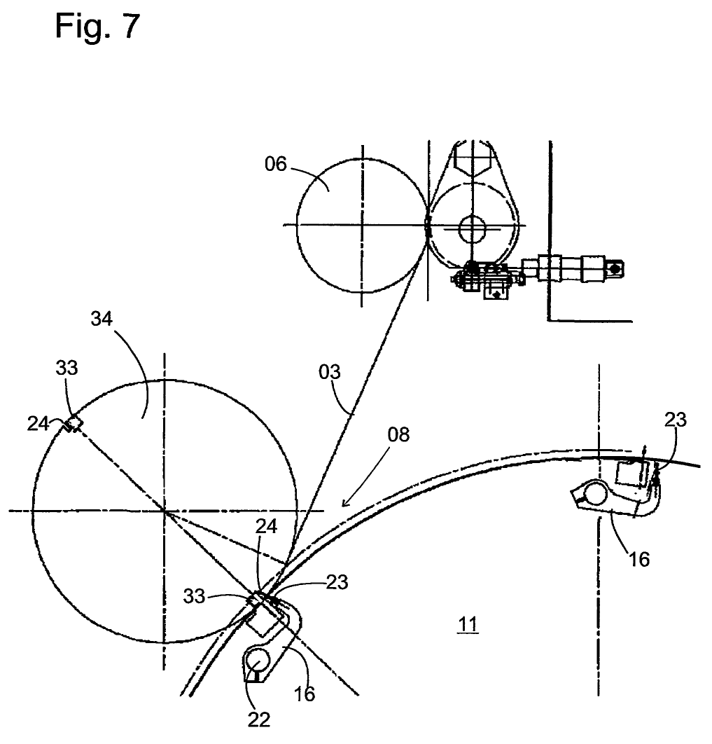

FIG. 6 shows a schematic side elevation view of a portion of an alternative preferred embodiment of the wheel folding apparatus in accordance with the present invention, wherein the cutters 14 are arranged on the transport cylinder 11. The circumference of the now cutting and transport cylinder 11 corresponds to more than five, and preferably corresponds to seven lengths of the signatures 21, 27. It supports more than five, and preferably supports seven cutters 14, which are evenly distributed over its circumference and, in its movement direction, which is a rotation in a counterclockwise direction in FIG. 1. The cylinder 11 also carries a holding device 16, such as, for example, a spur strip 16, closely behind each cutter 14. Such a spur strip 16, which is pivotable around the shaft 22 and which carries spur needles 23, is represented, in an enlarged view, in FIG. 7 at the moment of its passage through the cutting gap 08 formed by the cooperation of the cutting and transport cylinder 11 with a first counter cylinder 34.

Each one of the two identically constructed first and second counter cylinders 34 or 36 has a circumference corresponding to at least one, and preferably to two lengths of signatures 21, 27 to be produced from the webs 03, 04. Each cylinder 34 on 36 supports at least one, and preferably supports two counter-cutting strips, such as, for example, hard rubber strips, that are sunk into its circumferential surface, and which are used as stops 33 for the cutter 14. Each cylinder 34 or 36 also has a groove 24 which is located closely behind each stop 33 and which is utilized for receiving the tips of the spur needles 23 of the spur strips 16 which had been extended past the circumference of the cutting and transport cylinder 11 during the passage of the spur strips 16 through the cutting gap 08 or 09.

In the position of the wheel folding apparatus that is represented in FIG. 6, a cutter 14 of the cutting and transport cylinder 11 and a stop 33 of the first counter cylinder 34 just pass through the first cutting gap 08 and in the process cut through the inner web 03. A leading edge of the inner web 03, which has been formed by this cutting, has been speared on the spur needles 23 of a spur strip 16, which had been extended shortly before reaching the cutting gap 08. These spur needles 23 of the extended spur strip 16 continue to hold the newly formed leading edge of the inner web 03 firmly during its further transport on the surface of the cutting and transport cylinder 11.

The signature 21, which has been cut off the inner web 03 in this way, is further conveyed on the cutting and transport cylinder 11 to the second cutting gap 09, where the outer web 04 is placed on top of it. This outer web 04 is also speared by the spur needles 23 of the spur strip 16 and is cut by the same cutter 14. Since the cutters 14 and the spur strips 16 do not move with respect to their circumferential location on the cutting and transport cylinder 11 between the time of their passage through the first cutting gap 08 and the second cutting gap 09, there is no danger that the signatures 21, which had been cut off the web 03 in the first cutting gap 08, will be cut again during their passage through the second cutting gap 09.

At the locations of the first and second cutting gaps 08 and 09, the tips of the spur needles 23, as is shown in FIG. 7 extend farther past the circumference of the cutting and transport cylinder 11 than do the cutters 14. This is done in order to assure that the spur needles 23 have already penetrated through the webs 03 or 04 before the latter are being cut by the cutter 14.

The angular distance between the two cutting gaps 08, 09 is approximately 50° in the example represented in FIGS. 6 and 7. This angular distance can differ from an angular distance between the spur strips 16 from each other, which is preferably 51.5°, or a multiple thereof, so that cutting is not performed simultaneously at both cutting gaps 08, 09. Even a half-number multiple of this value is disadvantageous from the point of view of avoiding vibrations.

Following its passage through the cutting gap 09, each spur strip 16 supports a total product which is comprised respectively of a signature 21 cut off from the inner web 03 and a signature 27 cut off from the outer web 04. Seven products are formed with each revolution of the transport cylinder 11, the same as if both webs 03, 04 had been brought along in the customary manner via a common inlet 01, or 02. Since the cutting off of each individual signature 21, 27 is spread over two cutting steps at the first and second cutting gaps 08, 09, the force which must be employed in each cutting step is less. Accordingly, satisfactory, even running of the machine can be more easily maintained, and the demands made on the mechanical load- bearing capability of the cutting device are less than if both webs were fed in via a common inlet 01, 02.

Furthermore, at least five, and preferably seven folding blades, which are not specifically represented in FIGS. 6 and 7, are attached to the cutting and folding cylinder 11 and which folding blades, each time they reach a folding gap 19, that is formed between two folding rollers 17 and 18 which are placed in a contactless manner against the cutting and transport cylinder 11, are extended for use in transferring the products that are being transported on the cutting and transport cylinder 11 into the folding gap 19 in a manner which is generally known, and fold them. The now folded products pass through the folding gap 19 and, in a generally known manner, fall onto a paddle wheel, which is also not represented in the drawings since it is known, and are placed by it on a conveyor belt.

A modified embodiment of a cutting device in accordance with the present invention differs from the one represented in FIG. 6 in that it has only a single inlet 02 for a single web 04 to be cut. Reference is made to FIG. 6 in describing this embodiment, wherein the first inlet 01, the inner web 03 and the first counter cylinder 34 are assumed not to exist.

It is possible that each one of the webs 03, 04 has identical patterns A and B one behind the other, or in the transport direction. Preferably, these patterns A and B are printed by at least one forme cylinder of a printing unit, that is not specifically shown and which carries two identical patterns A and B on its circumference. The webs 03, 04 are conducted on top of each other, so that signatures with patterns A and B resting on top of each other are formed, each of which signatures is moved to the folding gap 19. To this end, it is not absolutely necessary for the transport cylinder 11 to have an odd division of its circumferential surface. Instead, it can also have an even division, which preferably is greater than 4 or 6.

Preferably, each of the patterns A, B, C, D identifies two newspaper pages, wherein A1, A2, B, B2, C1, C2, D1, D2 each identify one newspaper page. At least one web 03, 04 is to be understood by the identification web 03, 04. However, preferably this is to be understood as a continuous web consisting of several webs 03, 04 placed on top of each other.

In this case, the webs 03, 04 can each be imprinted by forme cylinders of printing units which either have a pattern A or B on the circumference, which is a single circumference, or which have two patterns A or B on the circumference, which is a double circumference. In the case of double circumference forme cylinders, two identical patterns A, A and B, B, or two different patterns A, B can be arranged on the forme cylinder circumference.

Therefore, four modes of operation are possible, when employing the wheel folding apparatus in accordance with the present invention.

In a first and second mode of operation, both of the webs 03, 04 are brought together upstream of the first inlet 01 on the transport cylinder 11 and are cut by the use of a single cutting process.

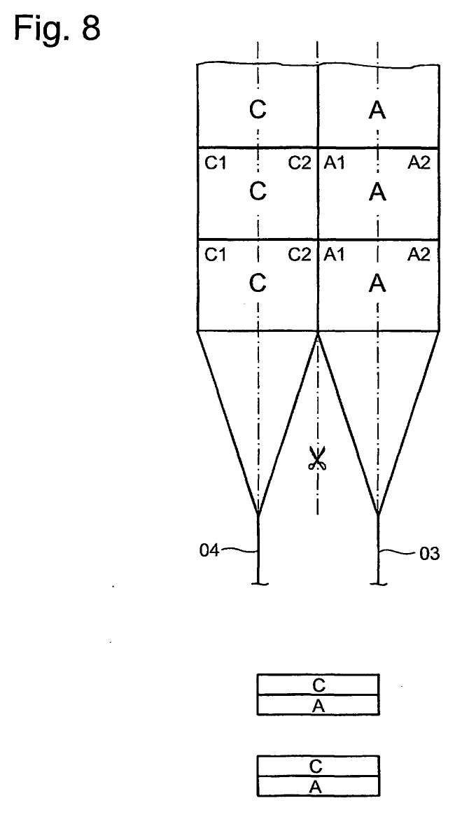

In a first mode of operation, the webs 03, 04 here each have the same patterns A or C, as can be seen in FIG. 8. The result is that identical products are formed, one behind the other, on the transport cylinder 11 during each revolution and are directly delivered to the folding gap 19.

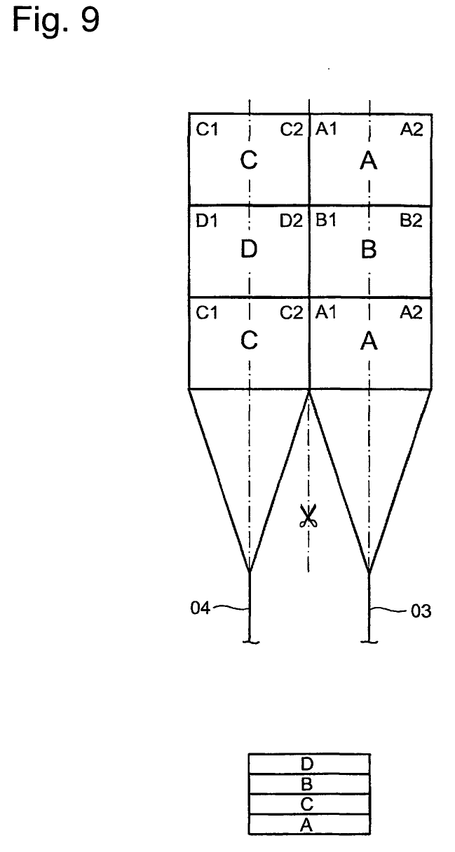

In a second mode of operation, that is corresponding to a collection operation, the webs 03, 04 each have alternating patterns A, B or C, D, respectively, situated one behind the other, as is represented schematically in FIG. 9, which patterns, in the course of a first revolution, are alternatingly deposited on the transport cylinder 11, which now acts as a collection cylinder, and which cylinder is provided with an odd number of fields. Fields of the transport cylinder 11, which carry signatures with only patterns A, C, move past the folding cylinders 17, 18 without the signatures being delivered into the folding gap 18. During a second passage of each such field past the inlet 01, it is additionally loaded with signatures with the patterns B, D. Only then are all four signatures delivered together to the folding gap 19.

In third and fourth modes of operation, the two webs 03, 04 are separately fed to the transport cylinder 11 via the inlet 01, 02.

In the third mode of operation, the webs 03, 04 carry patterns A, B or C, D alternatingly one behind the other in accordance with the representation shown in FIG. 9.

In this third mode of operation, and in the course of a first revolution of the transport cylinder 11, which is functioning as a collecting cylinder, a first field of the transport cylinder is loaded with a signature with the pattern A at the inlet 01, and with a signature with the pattern C at the inlet 02, so that every second spur strip 16 carries signatures with the patterns A, C when passing the folding cylinders 17, 18, and passes the folding cylinders 17, 19 without delivering the signatures. In the course of a second revolution, two signatures with patterns B, D from the webs 03, 04 are then conducted on the spur strips 16 which had previously received the patterns A,C.

Therefore, during the second revolution of the transport cylinders 11, signatures with patterns A, B, C, D on the spur strips 16 alternate with spur strips 16 which only carry signatures with the patterns A, C, or B, D wherein the finished products, consisting of four signatures with patterns A, B, C, D of each second field are transferred to the folding gap 19.

In a fourth mode of operation, the webs 03, 04 have the same patterns A, A, or C, C in succession, as is shown in FIG. 8, so that during each revolution of the transport cylinders 11 each spur strip 16 picks up signatures with the patterns A, C, which are directly transferred to the folding gap 19 when it is reached.

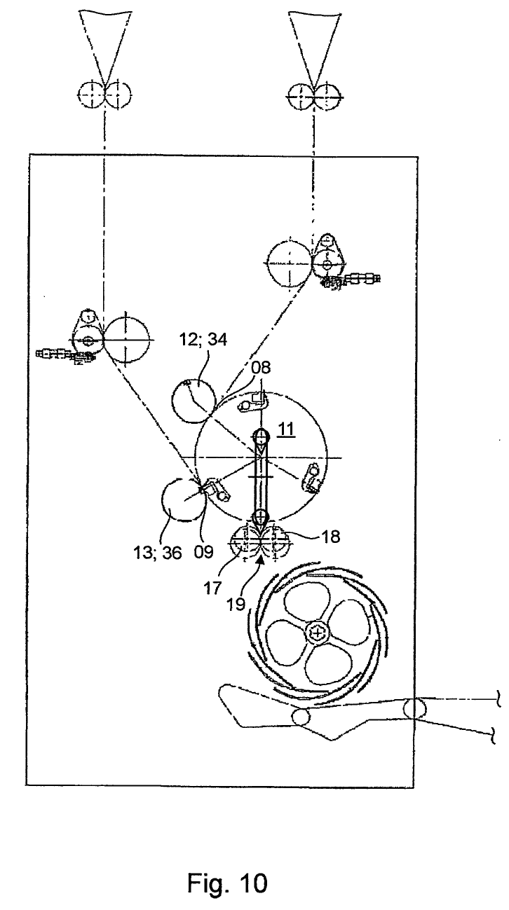

In a further preferred embodiment of the present invention, as seen in FIG. 10, the transport cylinder 11 has three holding devices 16, which preferably are provided as spur needle sets 16. Two folding blades have been arranged in the transport cylinder 11. These two folding blades are rotatably arranged on a rotatable support and are positioned inside a shell surface of the transport cylinder 11. This support for the two folding blades is arranged eccentrically with respect to the axis of rotation of the shell surface of the transport cylinder 11. The folding blade support rotates at a relative speed with respect to the shell surface of the transport cylinder 11. Two cutting arrangements are assigned to this transport cylinder 11, so that two cutting gaps 08, 09, which are arranged circumferentially offset, are provided on the circumference of the transport cylinder 11.

Each of these two cutting arrangements has rotatable cylinders 12, 13, or 34, 36, which are both provided either with at least one cutter 14 or with at least one stop 33 for a cutter 14 generally in the manner as has been described previously.

If the two cylinders 12, 13 have cutters 14, cooperating stops 33, and preferably three such stops 33, are arranged on the transport cylinder 11. If the cylinders 34, 36 have stops 33, then cooperating cutters 14, and preferably three such cutters 14, are arranged on the transport cylinder 11.

While preferred embodiemtns of a rotary folder comprising a cutting device for cross-cutting at least one web in accordance with the present invention have been set forth fully and completely herinabove, it will be apparent to one of skill in the art that various changes in, for example, the drives for the cylinders, the types of presses used to print the webs and the like could be made without departing from the true spirit and scope of the present invention which accordingly is to be limited only by the appended claims.

1-27. (canceled)

28. A wheel folding apparatus comprising:
a transport cylinder adapted to receive and to transport at least one web of material;
first and second folding rollers associated with said transport cylinder and defining a folding gap;
a first counter cylinder cooperating with said transport cylinder and defining a first cutting gap;
a second counter cylinder cooperating with said transport cylinder and defining a second cutting gap; and
means on said transport cylinder and said first and second counter cylinder to transversely cut said at least one web of material.

29. The wheel folding apparatus of claim 28 wherein each of said first and second counter cylinders is a cutting cylinder including at least one cutter.

30. The wheel folding apparatus of claim 29 further including stops on said transport cylinder and cooperating with said cutters on said cutting cylinders.

31. The wheel folding apparatus of claim 28 wherein said first counter cylinder and said transport cylinder cooperate to cut a first web of material and said second counter cylinder and said transport cylinder cooperate to cut a second web of material.

32. The wheel folding apparatus of claim 28 wherein said first and second counter cylinders are arranged sequentially on a circumference of said transport cylinder for phase-shifted cutting of said at least one web of material.

33. The wheel folding apparatus of claim 32 wherein a cut performed in said first cutting gap and a cut performed in said second cutting gap are spaced by less than 10 mm.

34. The wheel folding apparatus of claim 28 wherein said first and second counter cylinders are arranged on said transport cylinder offset in a circumferential direction of said transport cylinder.

35. The wheel folding apparatus of claim 29 including a first transport track for a first web of material and extending through said first cutting gap, said first cutting cylinder cutting a first signature of said first web during passage of said first web of material through said first cutting gap, and further including a second transport track for a second web of material, said second transport track meeting said first transport track before said second cutting gap, said second cutting cylinder cutting a second signature off said second web in said second cutting group during passage of said first and second webs of material through said second cutting gap.

36. The wheel folding apparatus of claim 35 wherein rotation of said first cutting cylinder and said second cutting cylinder are synchronized whereby said second cutting cylinder cutter is received in a cut made in said first web of material made by said first cutting cylinder cutter in said first cutting gap.

37. The wheel folding apparatus of claim 36 further including means on said transport cylinder adapted to separate leading and trailing edges of successive ones of said signatures cut in said first cutting gap from said first web of material.

38. The wheel folding apparatus of claim 37 wherein said separating means include signature leading end holding means adapted to shift said signature leading ends opposite to a signature transport direction prior to passage of said signatures through said second cutting gap.

39. The wheel folding apparatus of claim 38 wherein said separating means further includes a signature leading end holding means adapted to shift said second signature in said transport direction after passage through said second cutting gap.

40. The wheel folding apparatus of claim 28 wherein said transport cylinder includes at least one cutter.

41. The wheel folding apparatus of claim 40 further including at least one stop on each said counter cylinder and adapted to work with said at least one cutter on said transport cylinder.

42. The wheel folding apparatus of claim 40 further including a first transport track of a first web of material to be cut and extending through said first cutting gap, and a second transport track of a second web of material to be cut which meets said first transport track prior to said second cutting gap, both of said first and second transport tracks extending through said second cutting gap.

43. The wheel folding apparatus of claim 28 including at least a first cutter on said transport cylinder, a stop on said first counter cylinder adapted to cooperate with said at least first cutter to cut a signature off said at least one web of material, a holding device on said transport cylinder to hold said cut signature and at least a first transport track extending around said first counter cylinder and extending through said first cutting gap, said first counter cylinder being rotatable with said transport cylinder, said holding device transporting said cut-off signatures through said first cutting gap.

44. The wheel folding apparatus of claim 43 wherein said holding device is a spur strip.

45. The wheel folding apparatus of claim 44 wherein said spur strip carries a plurality of spur needles and is supported for rotation by a shaft, said spur needles crossing a circumference of said transport cylinder at a location which is changeable in accordance with a pivot position of said spur strip.

46. The wheel folding apparatus of claim 44 wherein said spur strip supports a plurality of spur needles having needle tips and needle bases and further wherein said spur strip is supported for pivotable movement about a shaft, said spur needle tips being located at a first distance from said shaft, said spur needle bases being located at a second distance from said shaft, said first distance being greater than said second distance.

47. The wheel folding apparatus of claim 37 wherein said means for moving apart said cut edges include radially displaceable segments of said transport cylinder and control means for effecting a radially outward movement of said radially displaceable segments after passage through said second cutting gap.

48. The wheel folding apparatus of claim 37 wherein said means for moving apart said cut edges include a groove on said transport cylinder and a strip on said second cutting cylinder and adapted to cooperate with said groove.

49. The wheel folding apparatus of claim 44 further including at least one spur strip needle receiving groove on said first cutting cylinder.

50. The wheel folding apparatus of claim 42 wherein said first transport track loops around said first counter cylinder at an entry to said first cutting gap.

51. The wheel folding apparatus of claim 28 including at least a first cutter on said transport cylinder, a first stop on said first counter cylinder adapted to cooperate with said at lest first cutter to cut a signature off said at least one web of material, a first transport path for said at least first web of material and extending through said first cutting gap, a second transport track for a second web of material and meeting said first transport rack after said first cutting gap, both said first and second transport tracks extending through said second cutting gap, said second counter cylinder having a second stop, said second stop cooperating with said cutter on said transport cylinder for cutting a second signature of said second web during passage of said cutter through said second cutting gap.

52. The wheel folding apparatus of claim 28 wherein said transport cylinder has at least five transport fields.

53. The wheel folding apparatus of claim 28 further including a web inlet associated with each said cutting gap.

54. The wheel folding apparatus of claim 28 wherein said transport cylinder is a folding blade cylinder.
